(19) United States
(12) Patent Application Publication
(10) Pub. No.: US 2014/0214529 A1
(43) Pub. Date: Jul. 31, 2014

(54) GOAL-BASED CREATION OF ADVERTISEMENTS FOR A SOCIAL NETWORKING SYSTEM

(71) Applicant: Facebook, Inc., Menlo Park, CA (US)

(72) Inventors: David Gross-Baser, Mountain View, CA (US); Fidji Nahema Simo, Palo Alto, CA (US); Himanshu Baweja, Menlo Park, CA (US)

(73) Assignee: Facebook, Inc., Menlo Park, CA (US)

(21) Appl. No.: 13/751,801

(22) Filed: Jan. 28, 2013

(51) Int. Cl. G06Q 30/02

(52) U.S. Cl. CPC G06Q 30/0276
USPC 705/14.45; 705/14.72; 705/14.69

(57) ABSTRACT

An advertisement interface receives an input identifying an object maintained by or otherwise accessible to a social networking system. A type associated with the object identified by the input is determined and one or more goals associated with the type are presented. Based on selection of a goal, one or more options are presented, where at least one of the presented options is associated with the selected goal. Hence, goals specific to a type of object may be presented and options specific to a selected goal are presented to increase advertisement effectiveness. Based on the selected options, an advertisement is created and displayed to other users of the social networking system.

### BACKGROUND

This invention relates generally to social networking systems, and in particular to creating advertisements for users of a social networking system.

A social networking system allows users to connect with and to communicate with other users of the social networking system. The users may be individuals or entities such as corporations or charities. To encourage exchange of information between users, social networking systems often maintain objects such as applications (e.g., a game playable within the social networking system), events (e.g., a concert that users may attend), and pages (e.g., pages constituting a particular user's presence on the system, including places, brand identity, and products associated with a user). The increasing popularity of social networking systems and the significant volume of objects maintained by social networking systems make social networking systems an ideal forum for advertising these objects.

Conventional social networking systems provide users with different options for creating an advertisement. Typical options are related to advertisement pricing and advertisement audience selection. For example, options for pricing and audience selection may include setting a campaign budget and showing an advertisement for an application to users that have not yet installed the application. However, because additional options for advertisement presentation and performance enhance advertisement effectiveness, advertisements created using conventional social networking systems are not optimized to achieve their goals.

### SUMMARY

A social networking system provides its users with different options to create an advertisement for presentation to other social networking system users. To increase the effectiveness of an advertisement, the social networking system allows a user to specify a goal for an advertisement and customizes the advertisements based on the specified goal. When an input to create an advertisement for an object is received by the social networking system, the social networking system determines the type of object corresponding to the input (e.g., a page, an application, an event, etc.). For example, the social networking system presents a list of candidate objects matching a received portion of the input, allowing the user to identify an object from the list without fully specifying an object in the input.

Once the type of object is identified by the social networking system, the user is presented with goals specific to the type of object. For example, if an input is received to create an advertisement for a page, the social networking system presents goals associated with a page, such as increasing a number of users expressing a preference for a page or increasing an amount of content posted to the page. When a goal is selected, the social networking system presents options associated with the selected goal, such as options to accomplish the selected goal. For example, if a goal of increasing content posted to a page is selected, a user is presented with options including a list of page posts to promote and types of stories shown in conjunction with the selected page post.

In one embodiment, after selecting one or more options associated with the selected goal, audience selection options are presented. The audience selection options allow identification of one or more characteristics of users to be presented with the advertisement or eligible to be presented with the advertisement. For example, an audience is specified as male users in the United States over the age of 21. Based on the selected options and the goal of the advertisement, the social networking system may generate a prediction of an audience likely to take an action associated with the goal and refines the target audience based on the prediction.

Additional options related to pricing may be presented during advertisement creation. Examples of pricing-related options include a budget for an advertising campaign, a schedule for advertisement presentation, a bid specifying an amount received by the social networking system and when the amount is received (e.g., each time a user interacts with the advertisement, each time a user is presented with the advertisement, etc.). In one embodiment, the social networking system may optimize the bid on behalf of the user based on factors including the advertisement goal and the selected pricing options.

In one embodiment, the social networking system directs a user interacting with a created and presented advertisement to a destination for accomplishing the advertisement's goal. For example, accessing an advertisement having the goal of acquiring new application users directs a user to a page maintained by the social networking system allowing the user to install the application. In one embodiment, information describing an advertisement's measured performance is presented to the user that created the advertisement. For example, if an advertisement's goal is to get new application users, the performance information shows the percentage of users shown the advertisement that installed the application (i.e., the percentage of “conversions” of the advertisement). The data presented may be organized in any suitable manner (e.g., by demographics, location, reach, frequency, page views, etc.).

### BRIEF DESCRIPTION OF THE DRAWINGS

FIG. 1 is a block diagram of a system environment in which a social networking system operates, in accordance with an embodiment of the invention.

FIG. 2 is a block diagram of a social networking system, in accordance with an embodiment of the invention.

FIG. 3 is a flow chart of a method for creating an advertisement, in accordance with an embodiment of the invention.

FIGS. 4A and 4B are examples of an advertisement user interface for creating an advertisement for a page maintained by the social networking system, in accordance with an embodiment of the invention.

FIGS. 5A and 5B are examples of an advertisement user interface for creating an advertisement for an application maintained by the social networking system, in accordance with an embodiment of the invention.

FIG. 6 is an example of an advertisement user interface for creating an advertisement for an event maintained by the social networking system, in accordance with an embodiment of the invention.

FIG. 7 is an example of presentation of advertisement performance metrics for an advertisement, in accordance with an embodiment of the invention.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Overview

A social networking system allows its users to create advertisements for presentation to other users. The social networking system determines a type of an object associated with a received input to create an advertisement and maintained by the social networking system (e.g., a page, an application, an event, etc.). Based on the type of object, one or more goals associated with the determined object type are presented to the user. The social networking system may associate different sets of goals with different object types. When the social networking system receives a selection of a goal, one or more options associated with the selected goal are presented. A different set of options may be associated with each goal, and an advertisement is created based on selected options. Additionally, the social networking system may further enhance the audience selection and pricing options for an advertisement based on the selected goal. In one embodiment, the selected goal determines the type of information presented to the user creating the advertisement to describe advertisement performance.

### System Architecture

FIG. 1 is a high level block diagram illustrating a system environment 100 for a social networking system 140. The system environment 100 shown by FIG. 1 comprises one or more client devices 110, a network 120, one or more third-party websites 130, and a social networking system 140. In alternative configurations, different and/or additional components may be included in the system environment 100. Additionally, the embodiments described herein can be adapted to online systems that are not social networking systems.

The client devices 110 comprise one or more computing devices capable of receiving input as well as transmitting and/or receiving data via the network 120. In one embodiment, a client device 110 is a conventional computer system, such as a desktop or laptop computer. In another embodiment, a client device 110 may be a device having computer functionality, such as a personal digital assistant (PDA), a tablet computer, a mobile telephone, a smart-phone or a similar device. A client device 110 is configured to communicate via the network 120. In one embodiment, a client device 110 executes an application allowing a user of the client device 110 to interact with the social networking system 140. For example, a client device 110 executes a browser application to enable interaction between the client device 110 and the social networking system 140 via the network 120. In another embodiment, a client device 110 interacts with the social networking system 140 through an application programming interface (API) that runs on the native operating system of the client device 110, such as IOS® or ANDROID™.

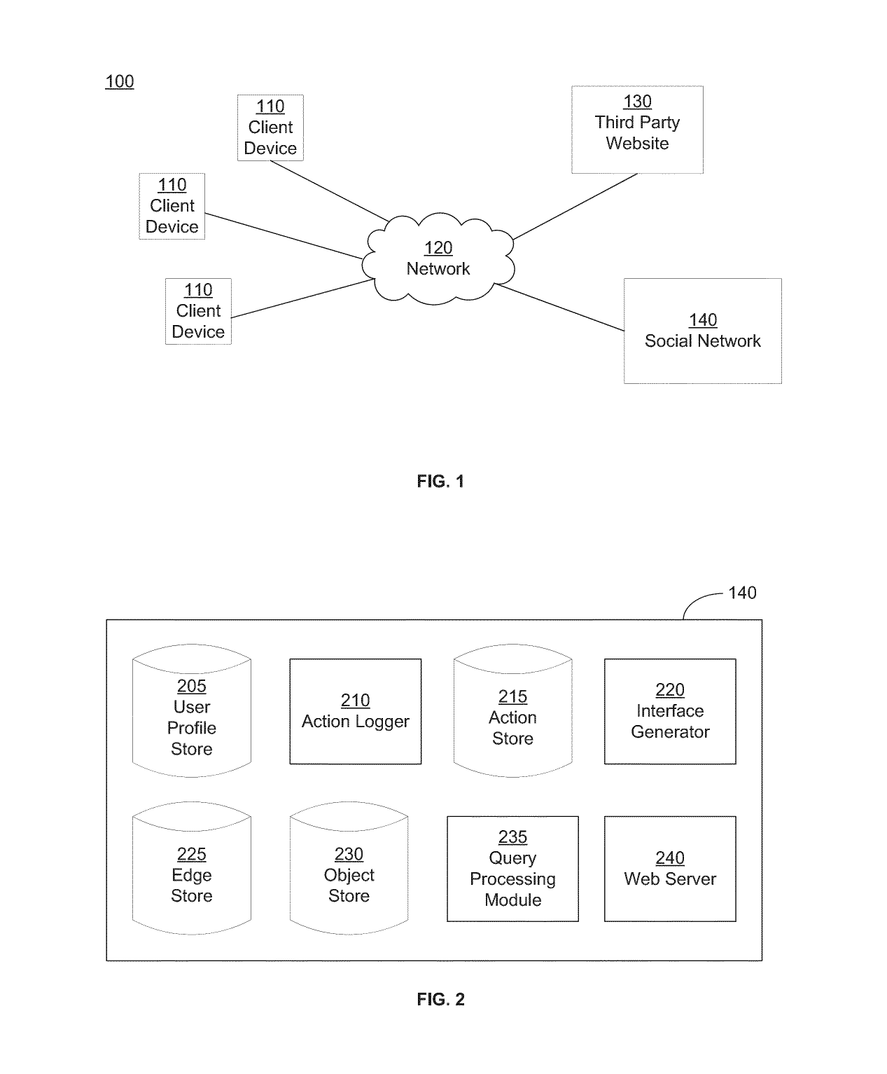

The client devices 110 are configured to communicate information via the network 120, which may comprise any combination of local area and/or wide area networks, using both wired and wireless communication systems. In one embodiment, the network 120 uses standard communications technologies and/or protocols. Thus, the network 120 may include communication channels using technologies such as Ethernet, 802.11, worldwide interoperability for microwave access (WiMAX), 3G, 4G, code division multiple access (CDMA), digital subscriber line (DSL), or other suitable communication technologies. The network 120 may use any suitable networking protocol or combination of networking protocols, such as multiprotocol label switching (MPLS), transmission control protocol/Internet protocol (TCP/IP), User Datagram Protocol (UDP), hypertext transport protocol (HTTP), simple mail transfer protocol (SMTP), and file transfer protocol (FTP). Data exchanged over the network 120 may be represented using technologies and/or formats including hypertext markup language (HTML), extensible markup language (XML), or any other suitable format. In addition, all or some of the communication channels may be encrypted using conventional encryption technologies such as secure sockets layer (SSL), transport layer security (TLS), and Internet Protocol security (IPsec). The third party website 130 may be coupled to the network 120 for communicating with the social networking system 140, which is further described below in conjunction with FIG. 2.

FIG. 2 is a block diagram of an example architecture of the social networking system 140. In the architecture shown by FIG. 2, the social networking system 140 includes a user profile store 205, an action logger 210, an action store 215, an interface generator 220, an edge store 225, an object store 230, a query processing module 235, and a web server 240. In other embodiments, the social networking system 140 may include additional, fewer, or different components. Conventional components such as network interfaces, security functions, load balancers, failover servers, management and network operations consoles, and the like are not shown so as to not obscure the details of the system architecture.

Each user of the social networking system 140 is associated with a user account and each user account is typically associated with a single user profile stored in the user profile store 205. A user profile includes declarative information about the user that was explicitly shared by the user, and may also include profile information inferred by the social networking system 140. In one embodiment, a user profile may include multiple data fields, each data field describing one or more attributes of the corresponding user of the social networking system 140. Hence, information stored in the user profile store 205 describes characteristics of the users of the social networking system 140, including biographic, demographic, and other types of descriptive information, such as work experience, educational history, gender, hobbies, preferences, location and any other suitable information. User profile information may also include data describing one or more relationships between a user and other users. Additionally, the user profile store 205 may also store other information provided by the user, for example, images or videos. A user profile in the user profile store 205 may also maintain references to actions performed by the corresponding user that are stored in the action store 215.

While user profiles are frequently associated with individuals, user profiles may also be stored for entities such as businesses or organizations. This allows an entity to establish a presence on the social networking system 140 for connecting to other social networking system users and for exchanging content with other social networking system users. While an administrator or individual associated with the entity creates the user profile for the entity, the entity is identified as the account-holder associated with the user profile. The entity may post information about itself, about its products, or provide other information to users of the social networking system 140 using a brand page associated with the entity's user profile. Other users of the social networking system 140 may connect to the brand page to receive information posted to the brand page or to receive information associated with the brand page. A user profile associated with the brand page may include information about the entity itself to provide users with background data or other information about the entity.

The action logger 210 receives communications describing user actions internal to and/or external to the social networking system 140 and populates the action store 215 with information describing the user actions. Such actions may include, for example, adding a connection to another user, sending a message to another user, uploading an image, reading a message from another user, viewing content associated with another user, attending an event posted by another user, among others. In addition, a number of actions described in connection with other objects are directed at particular users, so these actions are associated with those users as well. These actions are stored in the action log 220. Some actions may be performed by users while not connected to the social networking system 140, and these actions are logged and communicated to the social networking system 140 when a connection is established.

The action store 215 maintains information describing actions by social networking system users internal to the social networking system 140, as well as actions performed via third party websites 130 that communicate information to the social networking system 140. Users may interact with various objects maintained by the social networking system 140, and these interactions are stored in the action store 215. Examples of actions stored by the action store 215 include: commenting on posts, sharing links, and checking-in to physical locations via a mobile device or other client device 110. Additional examples of interactions with objects on the social networking system 140 included in the action store 215 include commenting on a photo album, communications between users, becoming a fan of a musician, adding an event to a calendar, joining groups, becoming a fan of a brand page, creating an event, authorizing an application, using an application, interacting with an advertisement and engaging in a transaction.

The interface generator 220 generates one or more interfaces allowing users to interact with the social networking system 140. For example, the interface generator 220 generates one or more web pages including content from the social networking system 140, such as images, video, profile information, or other data. The interface generator 220 also generates one or more interfaces for receiving information from social networking system users via a client device 110 and the network 120. For example, the interface generator 220 creates a form for a user to provide the social networking system 140 with biographic information for creating a user profile. When another user requests a profile page including information describing a user, the interface generator 220 retrieves data from the user's profile in the user profile store 205 and generates a representation of the information in the user profile for presentation.

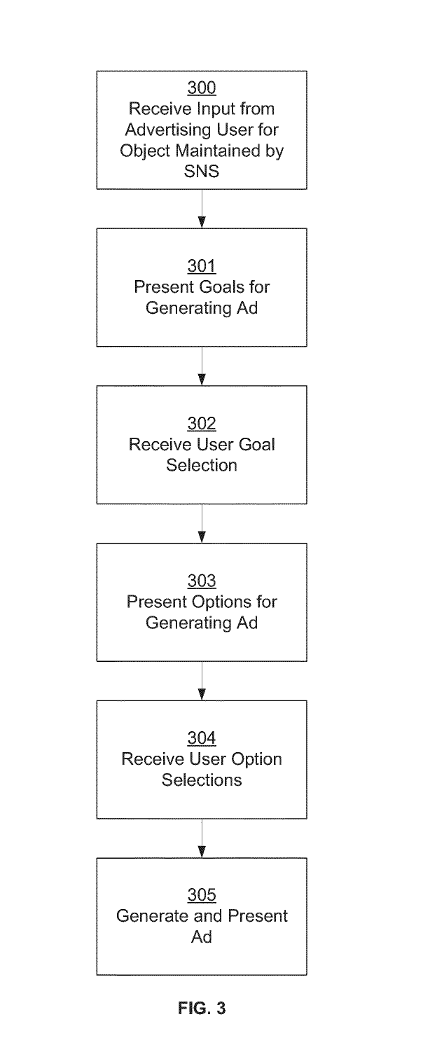

The interface generator 220 also generates an advertisement user interface for receiving information for creating an advertisement. For example, the advertisement user interface includes a single input field for receiving an input identifying an object maintained by or otherwise accessible to the social networking system 140 to be advertised. The object may be any object that it maintained within the social networking system environment, or it may be an object on a third-party system (e.g., a website) that is outside the domain of the social networking system 140. Based on a type of the object identified by the input, the advertisement interface presents one or more goals associated with the type. One or more options associated with a selected goal are subsequently presented by the advertisement interface. In one embodiment, the advertisement user interfaces is generated using one or more application programming interfaces (APIs) used by an advertising engine of the social networking system 140 that receives the requests to create advertisements. Presentation of options based on a selected goal for an advertisement is further described below in conjunction with FIGS. 3-6.

The edge store 225 includes information describing connections between users and other objects maintained by the social networking system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the social networking system 140, such as expressing interest in a page on the social networking system 140, sharing a link with other users of the social networking system 140, and commenting on posts made by other users of the social networking system 140.

The edge store 225 stores edge objects that include information about the edge, such as affinity scores for objects, interests, and other users. Affinity scores may be computed by the social networking system 140 over time to approximate a user's affinity for an object, interest, and other users in the social networking system 140 based on the actions performed by the user. A user's affinity may be computed by the social networking system 140 over time to approximate a user's affinity for an object, interest, and other users in the social networking system 140 based on the actions performed by the user. Computation of affinity is further described in U.S. patent application Ser. No. 12/978,265, filed on Dec. 23, 2010, which is hereby incorporated by reference in its entirety. Multiple interactions between a user and a specific object may be stored in one edge object in the edge store 225, in one embodiment. In some embodiments, connections between users may be stored in the user profile store 205, or the user profile store 205 may access the edge store 225 to determine connections between users.

The object store 230 stores information about content maintained by the social networking system 140. Different content items, which represent individual pieces of content provided by the social networking system 140 to users, are stored as objects in the object store 230. Examples of objects include a page post, a status update, a photo, a video, a link, a shared content item, a gaming application achievement, a check-in event at a local business, a brand page, or any other type of content. Objects may be created by users of the social networking system 140, such as status updates, photos tagged by users to be associated with other objects in the social networking system, events, groups or applications. In some embodiments, objects are received from third-party applications or third-party applications separate from the social networking system 140. An object in the object store 230 may represent an entity existing within the social networking system 140 (e.g., an application available on the social networking system), a virtual entity outside of the domain of the social networking system 140 (e.g., a website), or a physical entity (e.g., a sports team or a retail store).

The object store 230 includes information for presenting a content item to a user. For example, the object store 230 includes a media item or data for executing an application. Alternatively, the object store 230 includes a pointer or a reference to a destination associated with a content item, such as the uniform resource locator (URL) of an external media item. The object store 230 may also store metadata associated with the objects, such as a name describing the object (e.g. “Charles Williams” for a page for a person, “Birthday Reminder” for an application, or “Penguin Fanciers” for a group), an image representing the object (e.g., a user profile picture), or one or more tags assigned to the object by users (e.g. text strings “game,” “crime,” and “strategy” for a strategy game application). Different types of metadata may be associated with different types of objects, and a metadata associated with an object identifies the type of the object. For example, user identifiers are associated with a group object, a media type identifier (e.g., “video”) is associated with a media item object, and a user identifier is associated with a user object.

The query processing module 235 processes input received via an advertising interface. In one embodiment, the query processing module 235 parses text input received by the advertising interface to identify one or more objects maintained by the social networking system 140 corresponding to the input. For example, the query processing module 235 generates a list including candidate objects maintained by the social networking system 140 that match at least a portion of the received input. In one embodiment, the query processing module 235 limits identification of candidate objects corresponding to a received input to objects in the object story 230 associated with a user from which the input is received. The query processing module 235 may identify objects associated with the received input using one or more search processes, combine the results from the search processes, and filter the combined results to produce the list including candidate objects. The query processing module 235 is further described below in conjunction with FIGS. 3-6.

The web server 240 links the social networking system 140 via the network 120 to the one or more client devices 110, as well as to the one or more third party websites 130. The web server 240 serves web pages, as well as other web-related content, such as JAVA®, FLASH®, XML and so forth. The web server 240 may receive and route messages between the social networking system 140 and the client device 110, for example, instant messages, queued messages (e.g., email), text and short message service (SMS) messages, or messages sent using any other suitable messaging technique. A user may send a request to the web server 240 to store a content item in the object store 230 or to retrieve a content item from the object store 230. Additionally, the web server 240 may provide API functionality to send data directly to native client device operating systems, such as IOS®, ANDROID™, WEBOS® or RIM®.

### Advertisement Creation Overview

FIG. 3 illustrates one embodiment of a method for creating an advertisement. The query processing module 235 identifies a type of object associated with an input received 300 by the social networking system 140 to create an advertisement. In one embodiment, the query processing module identifies a type associated with an object selected from one or more candidate objects associated with a received input and presented via the interface generator 220. Examples of the type associated with the object associated with the received input include as a page, an application, an event, or any other suitable type.

In one embodiment, the advertisement user interface presents one or more candidate objects matching at least a portion of the received input. As additional portions of the input are received, the presented candidate objects may be dynamically updated. In one embodiment, candidate objects are identified using text-parsing technology and structured data. A type associated with each candidate object may be presented along with the candidate objects. The type associated with a selected candidate object is identified.

In one embodiment, the query processing module 235 operates in a user-specific context when a user is logged into the social networking system 140 to leverage information stored about the user in the user profile store 205, action store 215, edge store 225, and/or about the various objects in the object store 230 to select candidate objects likely to be of interest to the user based on the received portion of the input. For example, if a user has created a connection to APPLEBEE'S® restaurant, candidate objects associated with APPLEBEE'S® may be included in the selectable list of candidate objects when “Apple” is received. Retrieval of objects stored by a social networking system 140 in response to a query is further disclosed in U.S. application Ser. No. 12/816,377, filed on Jun. 15, 2010, issued as U.S. Pat. No. 8,239,364, which is incorporated herein by reference in its entirety.

The query processing module 235 may identify candidate objects maintained by the social networking system 140 based on the affinities of a user form which an input is received for various objects. In one embodiment, candidate objects for which a user has at least a threshold affinity are identified. The threshold affinity may be set by the social networking system 140 and specifies a minimum affinity of a user for an object before the query processing module 235 includes the object in the list of candidate objects. For example, if a user has created a connection to an object associated with APPLEBEE'S® restaurant (e.g., a single check-in indicating a visit to the restaurant) and a connection to an object associated with APPLE® Inc. (e.g., liking an associated page and posting several comments on the page), the presented candidate objects may be based on the user's affinities for the different objects. In this example, APPLEBEE'S® restaurant may not be selected as a candidate object, while APPLE® Inc. is selected, because the user's connections indicate at least the threshold affinity for APPLE® Inc. an less than the threshold affinity for APPLEBEE'S® restaurant.

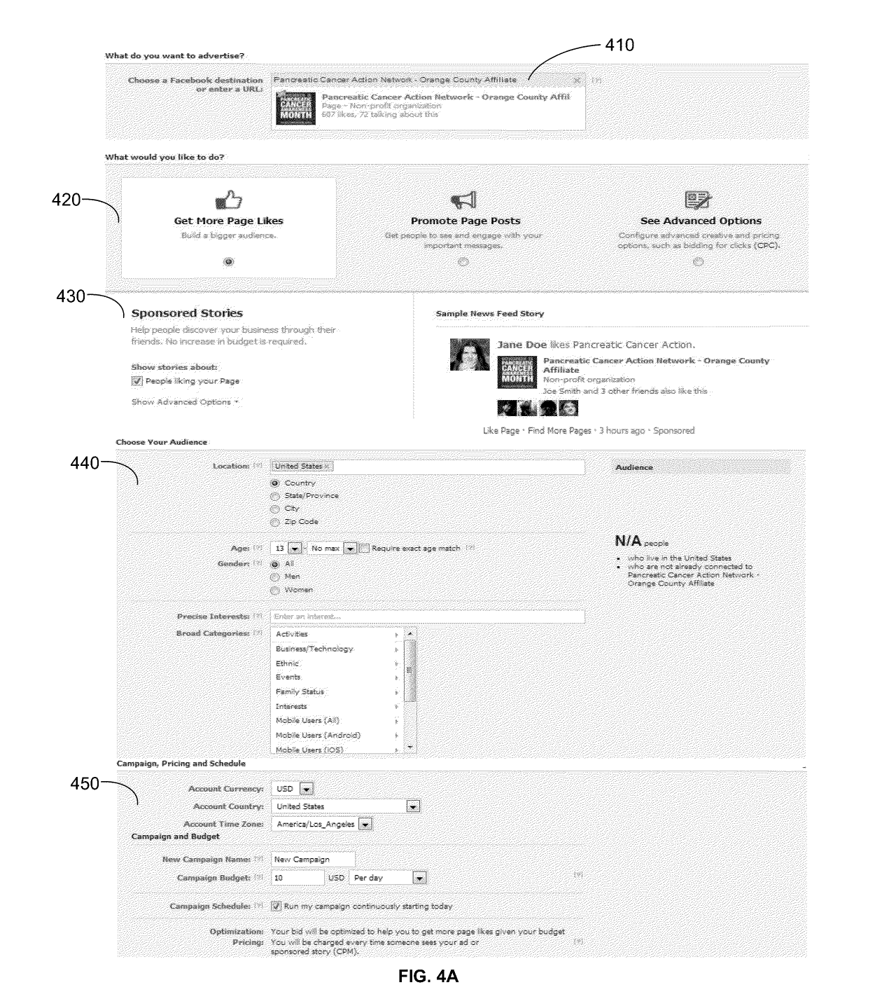

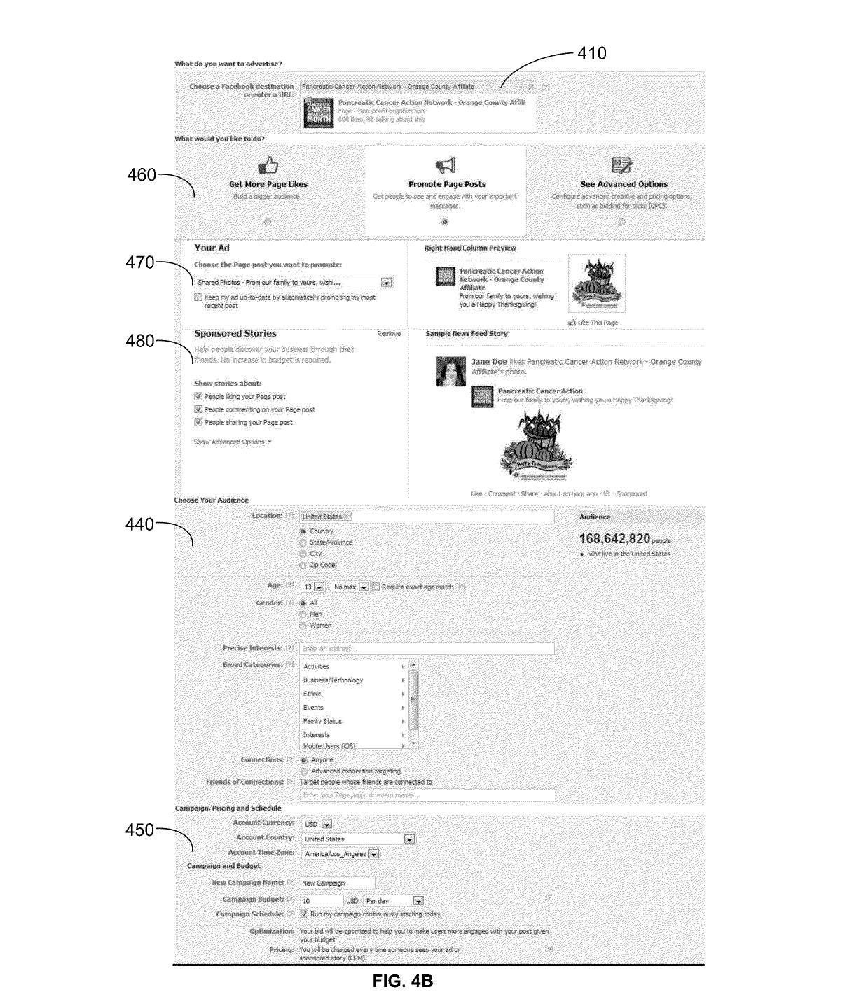

Based on the type associated with the object associated with the received input, one or more goals are presented 301 for customizing the advertisement via the interface generator 220. Hence, different goals may be presented when the input is associated with different types of objects. For example, different goals for configuring an advertisement are presented when the object has a page type, an application type, or an application type; this allows the advertisement goals to be customized for different types of objects. Goals for configuring an advertisement for different types of objects are further described below in conjunction with FIGS. 4A-6.

A selection of a goal is received 320, and one or more advertisement customization options are presented 303 based at least in part on the selected goal through the interface generator 220. Different advertisement customization options may be presented for different goals. For example, one or more of the presented options depend on the goal selected while other presented options are independent of the goal selected. Examples of advertisement customization options independent of the selected goal include specifying characteristics of an audience, specifying a budget, or other suitable options. In another example, the target audience options may be enabled, disabled, and/or defaulted to based on the selected goal (e.g., if the selected goal is to obtain more page likes, the interface may disable the option to target the ad to users who have already liked the page). In some embodiments, a preview of the generated advertisement based on the selected options is also shown. Examples of advertisement customization options dependent on the selected goal are further described below in conjunction with FIGS. 4A-6. One or more advertisement customization options are received 304, and the interface generator 220 generates 305 an advertisement based on the selected advertisement customization options that is presented to other users of the social networking system 140.

### Advertisement Customization

FIGS. 4A-6 are examples of various embodiments of an advertisement interface for creating advertisements associated with objects maintained by the social networking system 140. In the embodiments shown by FIGS. 4A-6, the advertisement interface, which is generated by the interface generator 220, includes an input field 410. Input identifying an object is received via the input field 410 and is communicated to the query processing module 235, which identifies one or more objects associated with the input as described above in conjunction with FIGS. 2 and 3. Each of the objects identified by the query processing module 235 is associated with a type, such as a page, an application, and an event.

In the examples of FIGS. 4A and 4B, the interface generator 220 presents one or more goals for customizing an advertisement associated with a page object. Examples of goals associated with a page object include increasing a number of social networking system users indicating a preference for the page 420 and increasing an amount of information posted to the page 460. Based on a selected goal, the interface generator 220 provides one or more options for customizing the advertisement. Examples of options for customizing the advertisement include an option to present sponsored stories, an option for audience selection 440, and one or more options for budgeting 450. One or more options for customizing the advertisement may be modified based on the selected goal. For example, if the selected goal is to increase a number of social networking system users indicating a preference for the page 420, the option to present sponsored stories enables presentation of stories describing users that expressed a preference for the page 430 and are connected to the user viewing the advertisement (the “viewing user”). As another example, if the selected goal is to increase an amount of information posted to the page 460, the option to present sponsored stories requests identification of a post to promote 470 to present stories describing users connected to the viewing user that interacted with the identified post 480 (e.g., users expressing a preference for the identified post, users sharing the identified post with other users, users commenting on the identified post, etc.). The audience selection options 440 allow specification of one or more characteristics of the users eligible to be presented with the created advertisement, such as location, age, gender, interests, and connections. Budgeting options 450 allow specification of one or more budgeting parameters for presenting the advertisement, such as currency, country, time zone, campaign name, campaign budget, campaign schedule, and pricing (e.g., bid amounts).

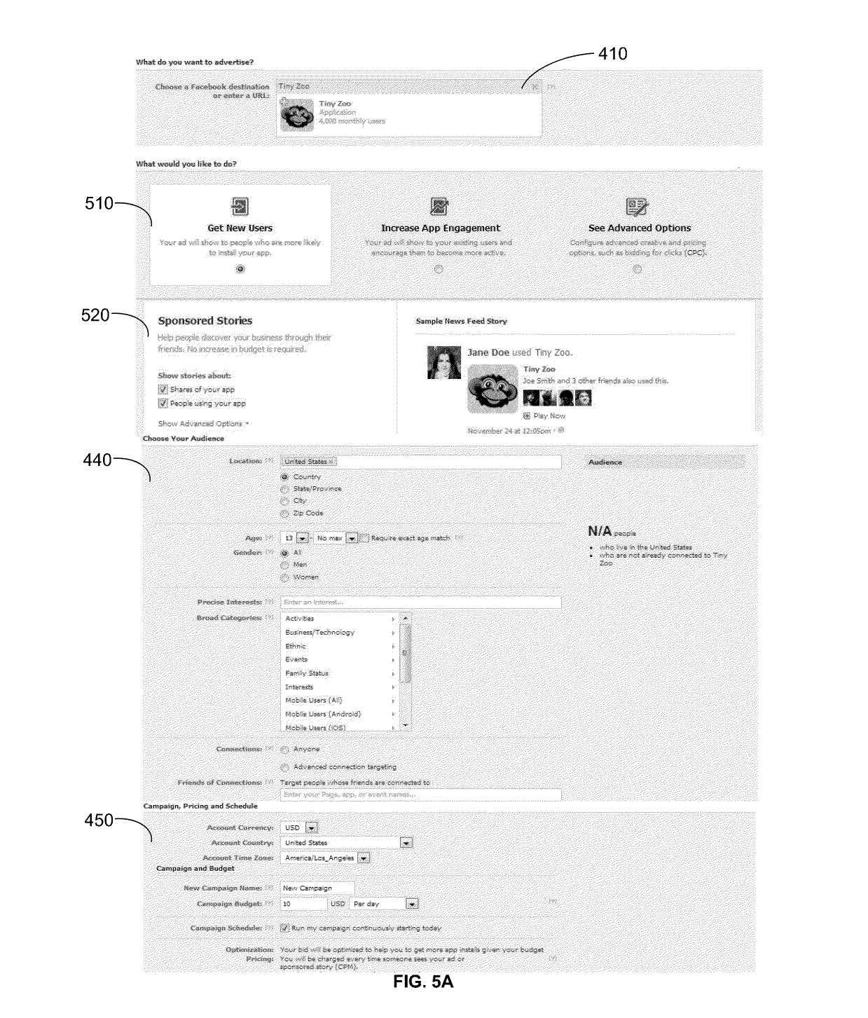

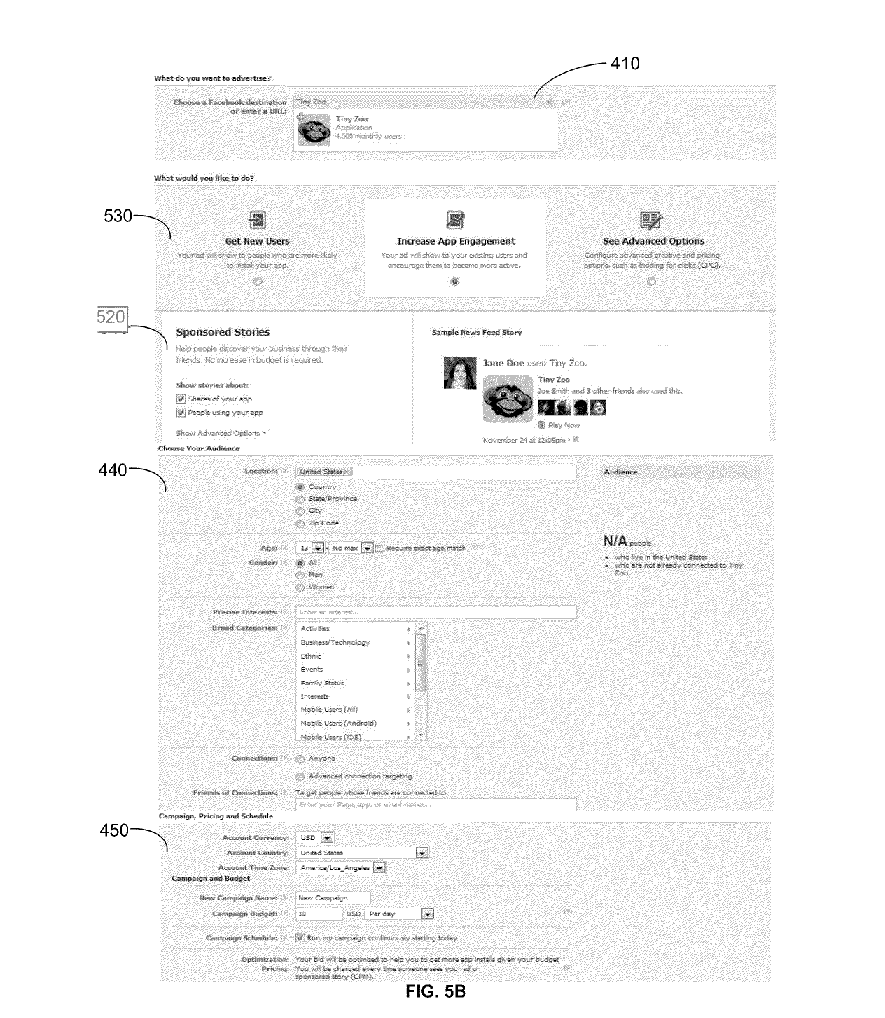

If the object associated with an input is an application object, one or more different goals for customizing an advertisement are presented, which are shown in FIGS. 5A and 5B. Examples of goals associated with an application object include getting new users 510 and increasing application engagement 530. Based on a selected goal, the interface generator 220 provides one or more options for customizing the advertisement, including an option for showing sponsored stories 520, an option for audience selection 440, and an option for budgeting 450. For example, if the option to get new users 510 is selected or the option to increase application engagement 530 is selected, the option for showing sponsored stories 520 prompts selection of stories describing users connected to a viewing user that shared the application and/or that used the application. The options relating to audience selection 440 and budgeting options 450 are described above in conjunction with FIGS. 4A and 4B.

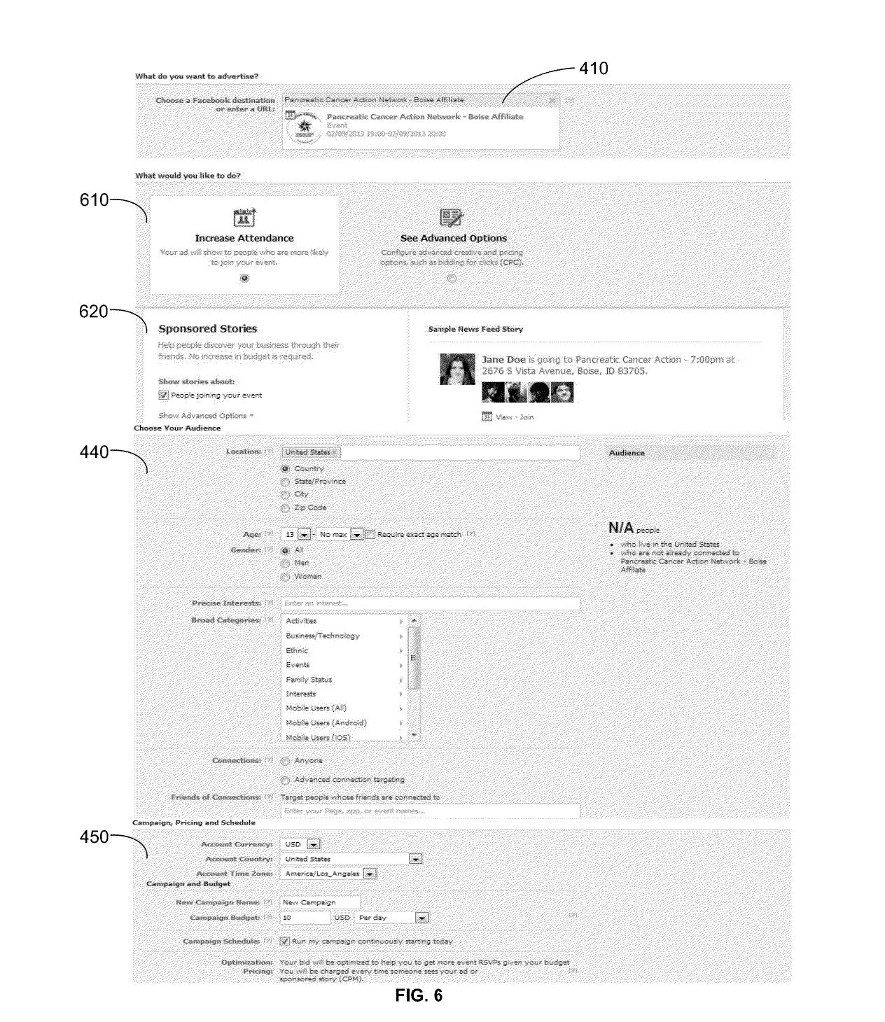

If the object associated with an input is an event object, one or more goals associated with the event object are presented, as shown in FIG. 6. An example of a goal associated with an event object is increasing event attendance 610. One or more presented options for customizing the advertisement are based on the selected goal. Examples of options for customizing the advertisement include an option for presenting sponsored stories 630, an option for audience selection 440, and an option for budgeting 450. If the goal to increase event attendance 610 is selected, the option for presenting sponsored stories 620 is modified to present stories describing users connected to a viewing user that join the event 620. The options relating to audience selection 440 and budgeting options 450 are described above in conjunction with FIGS. 4A and 4B.

In one embodiment, one or more of the above-described options are automatically populated with default values by the social networking system 140 based on information associated with a user creating the advertisement. For example, options regarding currency, country, and time zone may be preselected to be United States Dollars, United States, and America/Los Angeles, respectively, by the social networking system 140 when the social networking system 140 includes information that the user creating the advertisement is located in Los Angeles, Calif. The user may modify one or more of the default values selected, although the social networking system 140 may prevent one or more default values from being modified.

### Display of Advertisement Performance Metrics

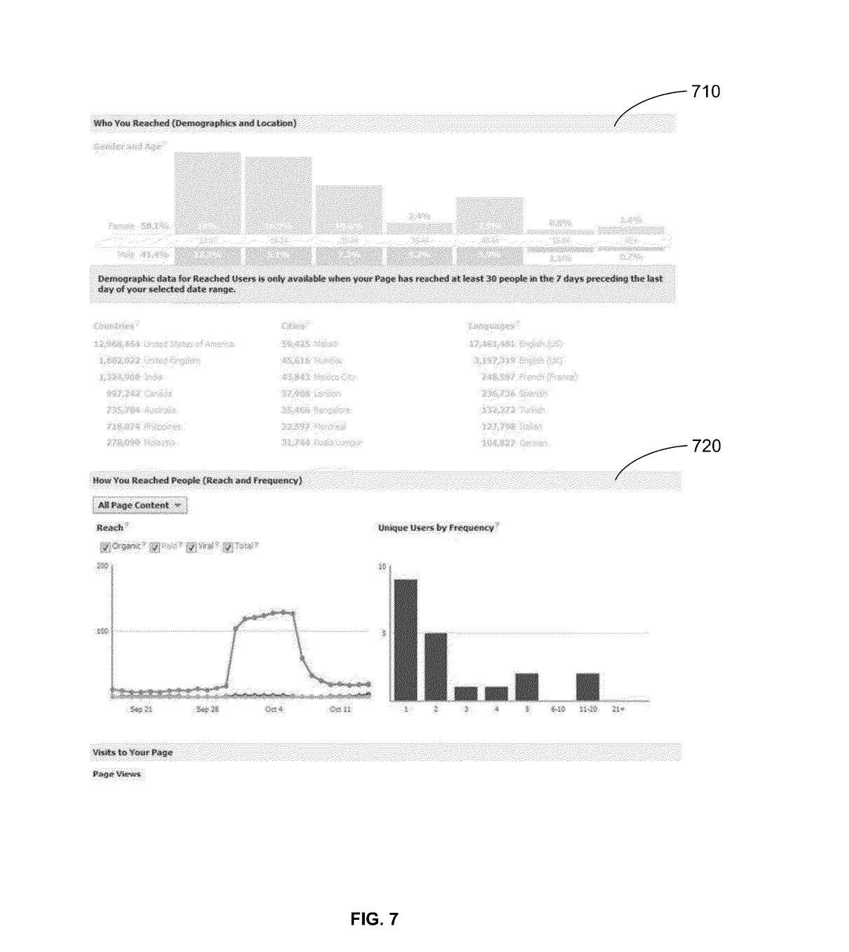

FIG. 7 is an example of an embodiment for presenting advertisement performance metrics to a user that created an advertisement on the social networking system 140. After creation and presentation of an advertisement to social networking system users, information about the performance of the advertisement relating to the goal selected for the advertisement is presented to the user that created the advertisement. For example, if the selected goal of an advertisement is to get new application users, one or more metrics indicating the percentage of users shown the advertisement that installed the application are presented. This allows the user that created the advertisement to identify actions by users presented with the advertisement resulting in occurrence of the selected goal (i.e., conversion events for the advertisement). The information describing conversion events may be organized in any suitable format, such as by demographics and location 710, by reach and frequency 720, by page views, or by any suitable method. The presentation of information describing conversion events may be modified based on the selected goal to simplify review of the performance metrics.

### Predictor Function Generation

In one embodiment, the social networking system 140 uses generates a predictor function to select a target audience for an advertisement based on the goal of an advertisement and one or more selected audience selection options. For example, the social networking system 140 selects an audience using historical information about user activity related to a selected goal to predict characteristics of users most likely to perform an action accomplishing the goal of the advertisement. For example, if the goal of an advertisement is to get new users for an application, the social networking system may select a target audience of users that have not installed the application and that have one or more common characteristics with users that previously installed the application. Generation of customized predictor functions for user actions is further disclosed in U.S. application Ser. No. 13/689,969, filed on Nov. 30, 2012, which is incorporated herein by reference in its entirety.

### Bid Optimization

Additionally, the social networking system 140 may determine a recommended bid for the advertisement based on the goal of an advertisement. A bid describes the compensation received by the social networking system 140 for presenting the advertisement and the criteria for the social networking system 140 receiving the compensation (e.g., $0.50 per click, $0.20 per impression, etc.). A higher bid corresponds to a greater frequency with which an advertisement is displayed. To optimize an advertisement's bid, the social networking system 140 may use one or more of: advertising budget, predicted performance, advertisement goal, and/or performance weightings. Optimization of bids for advertisements is further described in U.S. application Ser. No. 13/294,052, filed on Nov. 10, 2011, which is incorporated herein by reference in its entirety.

### Advertisement Destination

The goal selected for an advertisement may be used to determine the destination to which a user is directed when interacting with the advertisement. For example, the landing page of an advertisement is selected as a destination for accomplishing the selected goal rather than destination further describing the content of the advertisement. For example, if the goal of an advertisement is to increase attendance to an event at a theme park, a user accessing the advertisement is directed to a destination page for registering to attend the event rather than to a destination page providing from the general website for the theme park.

### Summary

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure. Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described. Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
receiving an input from a user of a social networking system identifying an object;
selecting one or more goals from a plurality of goals based on a type associated with the identified object;
presenting the selected one or more goals to the user;
receiving a selection of a goal from the presented goals;
selecting one or more options for defining an advertisement from a set of options for generating an advertisement, the options selected based on the selected goal;
presenting the selected options to the user;
receiving one or more selections of the presented options; and
generating an advertisement based on the one or more selections of the presented options.

2. The method of claim 1, wherein the type associated with the identified object is selected from a group consisting of: a page type, an application type, and an event type.

3. The method of claim 2, wherein the type associated with the identified object is the page type and the one or more goals are selected from a group consisting of: increasing a number of social networking system users indicating a preference for a page, increasing an amount of information posted to the page, increasing an amount of interaction with the page, and any combination thereof.

4. The method of claim 2, wherein the type associated with the identified object is the application type and the one or more goals are selected from a group consisting of:
increasing an amount of interaction with an application, obtaining additional users for the application, and any combination thereof.

5. The method of claim 2, wherein the type associated with the identified object is the event type and the one or more goals includes increasing a number of social networking system users attending an event.

6. The method of claim 1, further comprising:
generating a predictor function based at least in part on the selection of the goal from the presented goals, the predictor function predicting one or more characteristics of an audience likely to take an action associated with the selection of the goal.

7. The method of claim 1, further comprising:
determining a recommended bid for the advertisement based at least in part on the selection of the goal and the received one or more selections of the presented options.

8. The method of claim 1, further comprising:
presenting the generated advertisement to users of the social networking system;
storing actions performed by the users of the social networking system presented with the generated advertisement;
retrieving information describing actions performed by users based on the selection of the goal;
generating one or more metrics describing effectiveness of the advertisement based on the retrieved information;
presenting the one or more metrics.

9. The method of claim 1, further comprising:
presenting the generated advertisement to one or more users of the social networking system;
receiving an interaction with the generated advertisement from a user; and
responsive to receiving the interaction, directing the user to a destination determined from the selection of the goal and allowing the user to perform an action to satisfy the selection of the goal.

10. The method of claim 1, wherein receiving the input comprises:
responsive to receiving a portion of the input, presenting one or more candidate objects matching the received portion of the input.

11. The method of claim 10, wherein the one or more candidate objects are based in part on connections between a user from which the input was received and objects maintained by the social networking system.

12. The method of claim 10, wherein the one or more candidate objects include objects maintained by the social networking system connected to the user from which the input was received and for which the user from which the input was received has at least a threshold affinity.

13. A method comprising:
receiving an input identifying an object from a user of a social networking system;
determining a type associated with the identified object;
presenting a plurality of goals for an advertisement associated with the object, at least one of the one or more goals associated with the type associated with the identified object;
receiving a selection of a goal from the presented one or more goals;
determining one or more options for generating the advertisement based on the selection of the goal; and
presenting the determined one or more options to the user.

14. The method of claim 13, further comprising:
receiving a selection of one or more of the determined one or more options;
generating an advertisement based on the selection of one or more of the determined one or more options; and
presenting the generated advertisement to users of the social networking system.

15. The method of claim 13, wherein the type associated with the identified object is selected from a group consisting of: a page type, an application type, and an event type.

16. The method of claim 15, wherein the type associated with the identified object is the page type and a goal associated with the type associated with the identified object is selected from a group consisting of: increasing a number of social networking system users indicating a preference for a page, increasing an amount of information posted to the page, increasing an amount of interaction with the page, and any combination thereof.

17. The method of claim 15, wherein the type associated with the identified object is the application type and a goal associated with the type associated with the identified object is selected from a group consisting of: increasing an amount of interaction with an application, obtaining additional users for the application, and any combination thereof.

18. The method of claim 15, wherein the type associated with the identified object is the event type and a goal associated with the type associated with the identified object is increasing a number of social networking system users attending an event.

19. The method of claim 13, further comprising:
generating a predictor function based at least in part on the selection of the goal, the predictor function predicting one or more characteristics of an audience likely to take an action associated with the selection of the goal.

20. The method of claim 13, further comprising:
determining a destination page for the advertisement based on the selection of the goal, the destination page allowing a user to perform an action satisfying the selection of the goal.
